(19) United States
(12) Patent Application Publication
(10) Pub. No.: US 2004/0178345 A1
(43) Pub. Date: Sep. 16, 2004

(54) Efficient position sensing system

(75) Inventors: Kyong M. Park, Thousand Oaks, CA (US); Marcos A. Nassar, Los Angeles, CA (US); Michael C. Shum, Northridge, CA (US)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(73) Assignee: Kavlico Corporation

(21) Appl. No.: 10/385,935

(22) Filed: Mar. 10, 2003

(51) Int. Cl. G01F 23/292

(52) U.S. Cl. 250/357.1

(57) ABSTRACT

A highly efficient position or liquid level sensing system includes a central fluorescent fiber or rod, a transparent support for mounting the fluorescent fiber preferably in a liquid container or tank, and a float or other movable member extending around the fluorescent fiber for movement relative to the fiber. Light is directed from one end of the fluorescent fiber parallel to and around the fiber; and the side of the float or movable member facing the light reflects the incident light inward toward the fluorescent fiber. A first detector receives radiation from one end of the fiber. Detectors may be provided at both ends of the fiber, and the two outputs may be combined sustractively to provide a substantially linear signal output relative to the position of the float or movable member.

### BACKGROUND OF THE INVENTION

1. Field of the Invention

This invention relates to optical position sensing systems including fluid level sensor systems.

2. General Background

Reference is made to U.S. Pat. No. 6,333,512 (the '512 patent) granted Dec. 25, 2001, to Alvin R. Wirthlin, and entitled “Optical Gauge for Determining the Level of a Medium in a Container.”

The design disclosed in the '512 patent includes an optically clear tubular element with grooves along its length in which fluorescent optical fibers have been embedded (see FIGS. 1 and 2). A light source mounted atop the tube shines light down the bore of the tube. A spherical float inside the tube blocks the light to the section of the tube that lies below the surface of the liquid, and therefore to the corresponding section of the optical fibers. The section above the float is fully illuminated and a percentage of that light is carried by the optical fibers to a photodetector installed at the end of the fibers. As the float moves up and down with the level of the liquid, the length of the optical fibers that is exposed to the light varies correspondingly, and therefore the intensity of the light carried by the fibers to the photodetectors changes with liquid level.

One of the disadvantages of this approach is its lack of sensitivity at the lower half of the sensor. As the float goes down, the change in light intensity carried by the fibers decreases until it get buried by the total intensity coming from the upper section of the fibers, which now acts as a fixed background that produces a constant output. This results in higher sensitivity at the upper end of the sensor and very low sensitivity as the liquid level goes down, and the liquid container or tank is nearly empty. FIG. 3 shows this trend using sensitivity data taken from such sensor arrangement, with the light source and the photodetectors at the same end. FIG. 4 shows the output when the detector and the light source are at opposite ends of the fiber. The non-linear nature of the optical configuration aggravates the problem since the light intensity inside the tube is not constant due to the divergence of the light beam. Although one figure of the '512 drawings discloses input from both ends of the fiber, it is not clear how such signals could be meaningfully combined.

Another challenge with the design of the '512 patent is the low efficiency of the optical system since only a very small portion of the available light is collected by the fibers. The light source and the float radiate light in all directions, but the optical fibers, being located on the perimeter of the tube, gather light at only a very narrow angle, as shown in FIG. 5. This results in low intensity at the detector, requiring high power light sources and large electronic amplification.

### INVENTION SUMMARY

Our proposed design improvements address these issues by first changing the illumination strategy; Instead of using the float to block the light to a section of the fibers, we use a float with a focusing element so that only a small section of the fiber next to the float is fully illuminated. This eliminates the large background intensity that does not change with float position as discussed above relative to the '512 design. As the intensely illuminated spot on the optical fiber moves toward or away from the detector, the signal changes accordingly due to the intrinsic loss-per-unit-length in the fiber.

To address the low optical efficiency of the system we use a hollow float that allows a single fiber to be positioned at the optical axis of the system. The conical focusing surface of the float now concentrates all the light towards the center and onto the optical fiber. In this way virtually all of the available light is focused on the fiber, resulting in a high intensity light spot. Thus, the need for multiple fibers is eliminated, and a lower intensity light source can now be used.

The intrinsic non-linearity of the system was corrected by using two photodectors, one at each end of the fiber, and susbtractively combining the two outputs. As the light spot moves from one end of the fiber to the other, the signal from one detector increases while the signal from the other decreases. Subtracting one signal from the other results in a much more linear output curve, as shown in FIG. 7. This graph shows the curve from each detector separately, and the resulting curve when the two signals are subtracted.

The two-detector approach also provides benefits in terms of temperature compensation. Any temperature-induced changes to the optical fibers or light source will affect both detectors equally, and that effect will be cancelled out when the two signals are subtracted.

In accordance with an illustrative embodiment of the invention, therefore, an efficient optical liquid level sensor includes a central fluorescent fiber, a support for mounting the fiber in a container for liquid, and a light source for directing light along the length of the fiber substantially parallel to the fiber. A float extending substantially around the fiber is mounted to movement along the length of the fiber, as the liquid level changes. The float includes reflecting surfaces for directing the illumination toward the fluorescent fiber; and at least one detector is provided for receiving the varying intensity illumination from the fluorescent fiber as the float shifts in location.

Instead of a float, a movable member may be employed, with the position sensing system having the movable member coupled to any moving part to provide an electrical signal indicating the position of the part. Accordingly, the movable member may extend around the fluorescent fiber, and may be movable toward and away from the source of illumination. With this arrangement the position of a lever, a crank, a valve or any other mechanical member could be sensed and a corresponding electrical signal provided.

Additional features may include one or more of the following:

1. The reflecting surface on the float is preferably substantially conical.

2. Two photo detectors may be provided one at each end of the fiber, and the outputs may be subtractively combined to provide a substantially linear output.

3. The illumination may be provided by a point light source and a parabolic reflector.

4. The light detector assembly or other blocking element may be employed to block direct illumination from the light source to the fiber from the light source, thereby eliminating background light energization of the fiber.

Other objects, features and advantages will become apparent from a consideration of the following detailed description, and the accompanying drawings.

### BRIEF DESCRIPTION OF THE DRAWINGS

FIG. 1 is a schematic showing of a prior art optical sensor;

FIG. 2 is a schematic cross sectional view taken along the plane indicated by the numerals 2-2 in FIG. 1;

FIG. 3 is a diagram illustrating the loss of illumination in the prior art system of FIGS. 1 and 2;

FIGS. 4 and 5 are diagrams showing the photo detector output level from the detectors located at the top and bottom of the system of FIG. 1;

FIG. 6 is a schematic showing of a liquid level system illustrating the principles of the present invention;

FIG. 7 is a diagram showing the efficient illumination of the fluorescent optical fiber in the system of FIG. 6;

FIG. 8 is a plot of detector output from the top detector of FIG. 7, from the lower detector of FIG. 7, and a diagram of the sustractively combined outputs; and

FIG. 9 is a circuit diagram for subtractively combining the outputs from the detectors at the two ends of the system of FIG. 6.

### DETAILED DESCRIPTION OF THE PREFERRED EMBODIMENTS

While the specification describes particular embodiments of the present invention, those of ordinary skill can devise variations of the present invention without departing from the inventive concept.

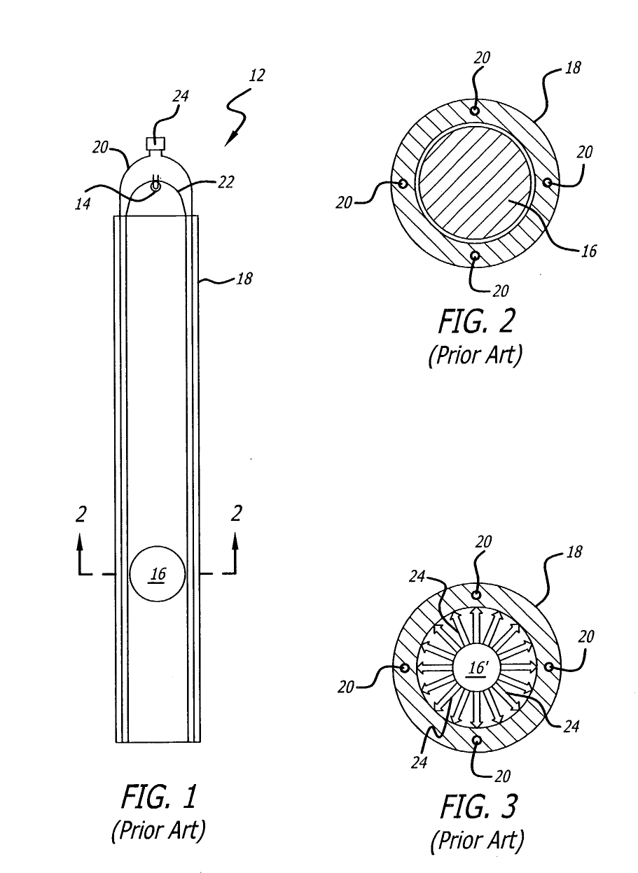

Returning more particularly to the drawings, FIGS. 1 through 5 of the drawings relate to the prior art arrangements as disclosed in U.S. Pat. No. 6,333,512 cited above.

FIG. 1 is a schematic showing of the optical sensor 12 of the -512 patent. It includes the incandescent light source 14, and the spherical float 16 which moves up and down within the transparent tube 18, as the fluid level changes. Optical fluorescent fibers 20 are embedded in the clear plastic tube 18. The tube 18 has many openings along its length so that the hollow ball float 16 will shift in position up and down within tube 18.

FIG. 2 is a schematic cross-section taken along the plane indicated by arrows 2-2 of FIG. 1. In this view, four optical fibers 20 are shown spaced around the support tube 18. The ball float 16 has a surface which reflects light from the light source 14, which is directed downwardly by the panabolic reflector 22. Light received by the fluorescent fibers 20 produces illumination which travels along fibers 20 to the upper photo detector 24.

FIG. 3 is a diagramatic showing of the radiation 24 from the ball 16′ outwardly. From this diagram, it is clear that only a very small fraction of the outwardly directed illumination 24 will impinge on the fibers 20; and accordingly the detected signals will be relatively weak.

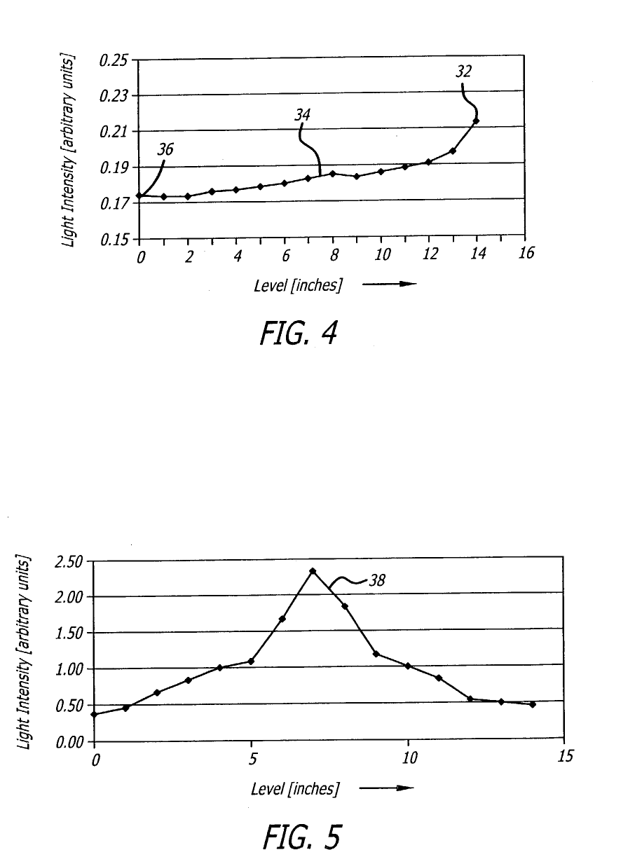

FIGS. 4 and 5 are plots taken from detectors at opposite ends of the sensor unit 12 of FIG. 1. Returning first to FIG. 4 with the detector at the top, the right hand end 32 of the plot 34 shows the output when the liquid container is full, and the left hand end 36 represents the condition when the tank or container is empty. As is evident from the plot 34, there is very little change in output if the container is nearly empty, and this is an obvious problem with this system.

FIG. 5 is the plot of a detector at the lower end of the sensor of FIG. 1. The plot is somewhat anomalous, in having an intermediate maximum 38 and is not fully understood. Factors which may be involved include the loss per unit length of the fluorescent fibers and the reduced intensity of the illumination at the lower end of the sensor assembly.

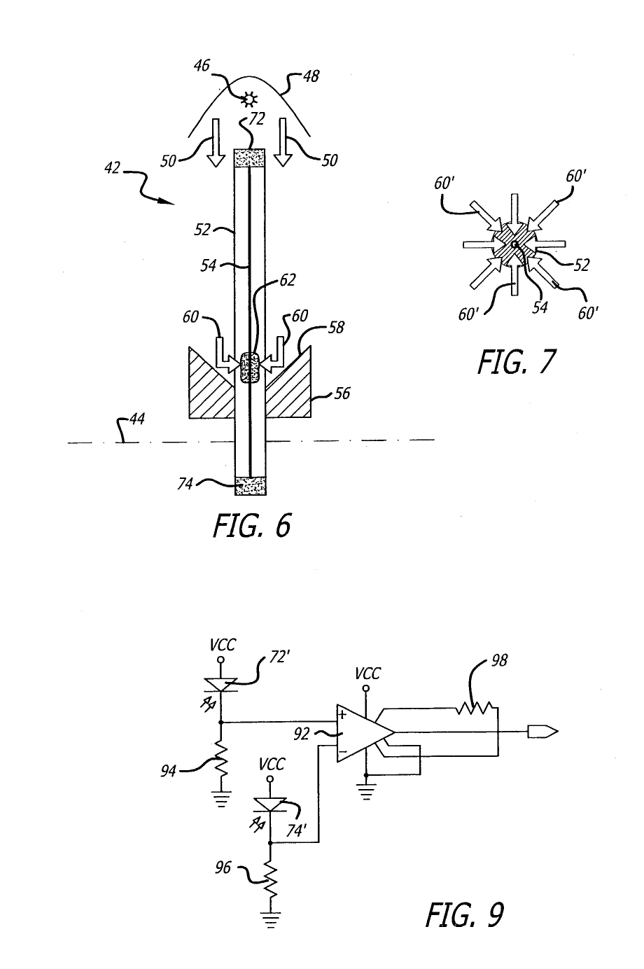

FIG. 6 is a diagramatic showing of a sensor system 42 illustrating the present invention, mounted within a container or tank, indicated schematically by the dash-dot lines 44. In the system of FIG. 6 a light source 46 and parabolic reflector 48 directs light as indicated by arrows 50 parallel to the transparent rod 52 having a central flourescent optical fiber 54. A hollow ring shaped float 56 is mounted around the rod 52 to move up and down with changes in liquid level.

The upper surface 58 of float 56 is formed of reflective material or has a reflective coating thereon, so that light impinging on surface 58 is directed inwardly to irradiate optical fiber 54 as indicated by the arrows 60 in FIG. 6. The high intensity illumination zone is indicated at reference numeral 62.

FIG. 7 is a diagramatic cross-sectional view showing radiation as indicated by arrows 60′ being directed inwardly through all 360° by conical surface 58.

Photo-Detectors 72 and 74 receive illumination from the fluorescent fiber 54, with the location of the excited illumination zone 62, and the loss per unit length of the fiber 54 being controlling factors regarding excitation of the detectors.

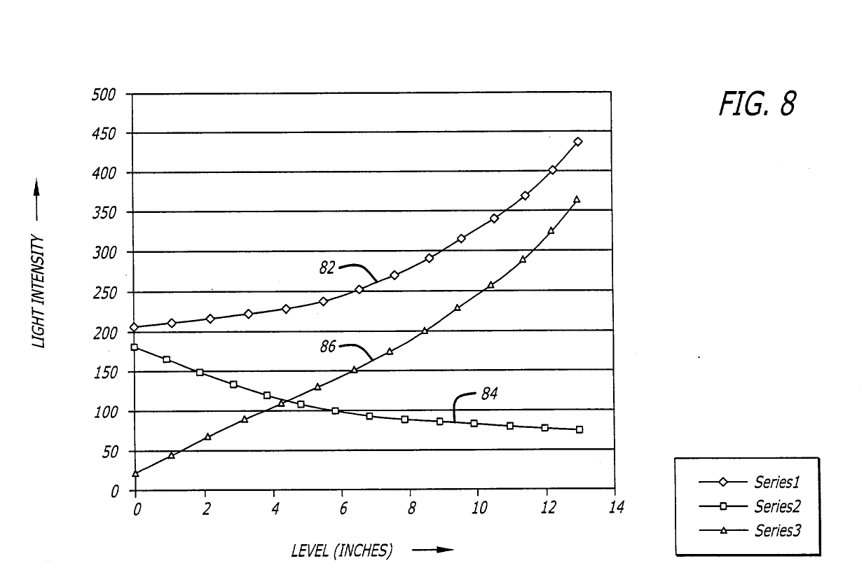

FIG. 8 shows the resulting illumination detected at detector 72 in curve 82 and for detector 74 at plot 84.

In FIG. 8, the left hand end of the plots relates to a nearly empty container or tanks, and the right hand end of the plots relates to the container or tank being nearly full. By substractively combining the two plots, a moderately linear composite plot 86 is obtained.

It is particularly to be noted that the output signal 86 does not have the undesired flat section as indicated at 36 in the plot of FIG. 4, at low liquid levels. Accordingly, a more accurate indication of fluid level is of course obtained. In addition, the available illumination from the light source 46 is more efficiently utilized, as it is virtually all directed inwardly toward the central optical fiber or rod 54.

FIG. 9 shows a typical circuit which may be employed to subtractively combine the detected signals at photodiodes 72′ and 74′. The circuit 92 for substractively combining the two inputs may be a type AD623 component. The resistor 94 may have a value of 3.3 megohms, Resistor 96 may have a value of 28 megohms, and resistor 98 may have a value of 50,000 ohms. It is to be understood, however, that other known circuits for substractively combining signals, may be employed.

For completeness, it may be noted that the light source 46 may be a incandescent lamp, or a high brightness light emitting diode. The fluorescent fibers may be one half or one millimeter in diameter and are available from Poly-Optical Products, Inc., 17,475 Gillette Ave., Irvine, Calif. 92614, or from Saint-Gohain Crystals and Detectors USA, 12345 Kinsman Rd., Newbury, Ohio 44005. The fluorescent number may be flexible or fairly stiff, and will be referenced as a fiber in the specification and claims.

In conclusion, in the foregoing detailed description and in the accompanying drawings, one preferred embodiment of the invention has been shown and described in detail. It is to be understood, however, that various changes and modification may be made without departing from the spirit and scope of the invention. Thus, by way of example and not of limitation, other types of optical fibers, light sources and photo-detectors may be employed. Also, instead of entirely encircling the central fiber, and using a single incandescent light source, two or more light emitting diodes could be employed, directing light parallel to the central fiber, with the float having appropriately oriented reflecting surfaces for directing illumination toward the central optical fiber. Further, two or more adjacent centrally located optical fibers could be employed instead of one. Also, instead of employing radiation in the visible range, the sensor may employ radiation in the infrared or ultra-violet spectral ranges or at other available frequency ranges. Accordingly, the invention is not limited to the specific embodiment shown and described in detail hereinabove.

We claim:

1. A liquid level sensing system comprising
a central fluorescent fiber;
a transparent support for mounting said fluorescent fiber in a liquid container;
a light source for directing illumination parallel to and around said fluorescent fiber;
a float extending around said fluorescent fiber, said float including a reflecting surface for directing said illumination toward said fluorescent fiber; and
a photo sensor coupled to one end of said fluorescent fiber for receiving variable illumination as said float moves with the level of liquid in said container changes.

2. A liquid level sensing system as defined in claim 1 wherein said reflecting surface is substantially conical in configuration.

3. A liquid level sensing system as described in claim 1 wherein said light source includes a substantially parabolic reflecting surface for directing illumination from said light source toward said float and parallel to and around said fluorescent fiber.

4. A liquid level sensing system as defined in claim 1 wherein two photo sensors are mounted, one at each end of said fluorescent fiber and wherein circuitry is provided for subtractively combining outputs from said two photo sensors.

5. A liquid level sensing system as defined in claim 1 wherein said float is ring shaped.

6. A liquid level sensing system as defined in claim 1 wherein a blocking element is provided for blocking direct illumination of the fiber by the light.

7. A liquid level sensing system comprising
a central fluorescent fiber;
a transparent support for mounting said fluorescent fiber in a liquid container;
a source of illumination for directing radiation parallel to and around said fluorescent fiber;
a float extending around said fluorescent fiber, said float including a reflecting surface for directing said radiation toward said fluorescent fiber; and
a sensor coupled to one end of said fluorescent fiber for receiving variable radiation as said float moves with changes in the level of liquid in said container.

8. A liquid level sensing system as defined in claim 7 wherein said reflecting surface is substantially conical in configuration.

9. A liquid level sensing system as described in claim 7 wherein said source of illumination includes a substantially parabolic reflecting surface for directing radiation from said source toward said float and parallel to and around said fluorescent fiber.

10. A liquid level sensing system as defined in claim 7 wherein two photo sensors are mounted, one at each end of said fluorescent fiber and wherein circuitry is provided for subtractively combining outputs from said two sensors.

11. A liquid level sensing system as defined in claim 7 wherein said float is ring shaped.

12. A liquid level sensing system as defined in claim 7 wherein a blocking element is provided for blocking direct illumination of the fiber.

13. A liquid level sensing system comprising a central optical fiber;
a transparent support for mounting said optical fiber in a liquid container;
a source for directing illumination parallel to and around said optical fiber;
a float extending around said optical fiber, said float including a reflecting surface for directing said illumination toward said optical fiber; and
a photo sensor coupled to one end of said optical fiber for receiving variable illumination as said float moves with the level of liquid in said container changes.

14. A liquid level sensing system as defined in claim 13 wherein said reflecting surface is substantially conical in configuration.

15. A liquid level sensing system as described in claim 13 wherein said light source includes a substantially parabolic reflecting surface for directing illumination from said light source toward said float and parallel to and around said optical fiber.

16. A liquid level sensing system as defined in claim 13 wherein two photo sensors are mounted, one at each end of said optical fiber and wherein circuitry is provided for subtractively combining outputs from said two photo sensors.

17. A liquid level sending system as defined in claim 13 wherein said float is ring shaped.

18. A liquid level sensing system as defined in claim 13 wherein a blocking element is provided for blocking direct illumination of the fiber.

19. A position sensing system comprising
a central fluorescent fiber;
a support for mounting said fluorescent fiber;
a source of illumination for directing radiation parallel to and around said fluorescent fiber;
a movable member extending around said fluorescent fiber, said movable member including a reflecting surface for directing said radiation toward said fluorescent fiber; said movable member being movable along said fiber toward and away from said illumination source; and
a sensor coupled to one end of said fluorescent fiber for receiving variable radiation as said movable member changes position.

20. A position sensing system as defined in claim 19 wherein said reflecting surface is substantially conical in configuration.

21. A position sensing system as defined in claim 19 wherein two photo sensors are mounted, one at each end of said fluorescent fiber and wherein circuitry is provided for subtractively combining outputs from said two sensors.

22. A position sensing system comprising:
a central optical fiber;
a transparent support for mounting said optical fiber;
a source for directing illumination parallel to and around said optical fiber;
a movable member extending around said optical fiber, said movable member including a reflecting surface for directing said illumination toward said optical fiber; said movable member being movable along said optical fiber toward and away from said source of illumination; and
a sensor coupled to one end of said optical fiber for receiving variable illumination as said movable member changes position.

23. A position sensing system as defined in claim 22 wherein said reflecting surface is substantially conical in configuration.

24. A position sensing system as defined in claim 22 wherein two sensors are mounted, one at each end of said optical fiber and wherein circuitry is provided for subtractively combining outputs from said two photo sensors.
